(19) United States
(12) Patent Application Publication
(10) Pub. No.: US 2007/0156487 A1
(43) Pub. Date: Jul. 5, 2007

(54) Object model on workflow

(75) Inventors: Andres Sanabria, Sammamish, WA (US); Constantin Mihai, Bellevue, WA (US); Nikhil Kothari, Sammamish, WA (US); Israel Hilerio, Kenmore, WA (US); Michael Harder, Bellevue, WA (US); Paul E. Maybee, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/321,820

(22) Filed: Dec. 29, 2005

(51) Int. Cl. G06F 9/46

(52) U.S. Cl. 705/8

(57) ABSTRACT

Systems and methods that objectify view of workflows and management behavior via an access component that supplies access to the real workflow instance. The subject innovation enables custom features to be defined for interaction during run time. For example, custom features (e.g., strongly typed workflow) can include, a method(s), an event(s), a proper(ies), an interface and the like. Accordingly, the workflow can be exposed as an object type or class, wherein new members can be added and the workflow extended.

### BACKGROUND

Typically all software employed in enterprises today support business processes. Some of such processes are entirely automated, relying solely on communication among applications, while others rely on people to initiate the process, approve documents the process uses, resolve any exceptional situations that arise, and more. In either case, it is common to specify a discrete series of steps known as a workflow that describes the activities of the people and software involved in the process. Once such workflow has been defined, an application can be built around that definition to support the business process.

Put differently, workflow generally is the flow of information and control in such organizations. Businesses continually strive to define, document, and streamline such processes in order to effectively compete. In a business setting, these processes include sales and order processing, purchasing tasks, inventory control and management, manufacturing and production control, shipping and receiving, accounts payable, and the like.

Computer systems and associated software now provide tools with which businesses and other organizations can improve their workflow. Software tools can be used to model business workflow processes or schedules and identify inefficiencies and possible improvements. In addition, where a process involves exchanging data between people, departments, plants, or even between separate companies, computer systems and networks can be used to implement such exchanges. These systems and software tools are further able to implement large-scale computations and other data or information processing that are typically associated with business related information.

Accordingly, workflow management includes the effective management of information flow and control in an organization's business processes, wherein automation of such information processing has led to many efficiency improvements in the modem business world. Moreover, such automation of workflow management is now allowing businesses and other organizations to further improve performance by executing workflow transactions in computer systems, including global computer networks, such as the Internet.

A typical workflow-based application often requires a plurality of conditions to be satisfied. For example, one such condition is the ability to make decisions based on business rules. This can include simple rules, (e.g., like as a yes-or-no decision based on the result of a credit check), and more complex rules, (e.g., the potentially large set that must be evaluated to make an initial underwriting decision.) Another requirement is communication with other software and other systems outside the workflow. For example, an initial request can be received from one part of the application, while some aspects, (e.g., contacting a credit service) can require communication using other web services or technologies. A further condition to be satisfied is the proper interaction of the workflow with users. For example, the workflow should typically be able to display a user interface itself or interact with human beings through other software. Moreover, another condition that needs to be satisfied is the ability to maintain state throughout the workflow's lifetime. Accordingly, creating and executing a workflow in software poses unique challenges.

For example, some business processes can take hours, days, or weeks to complete, and maintaining information about the workflow's current state for such length of time is demanding. Moreover, such kind of long-running workflow will also typically communicate with other software in a non-blocking way, and an asynchronous communication can pose difficulties. At the same time, while modeling fixed interactions among software is relatively straightforward, consumers tend to continuously require additional flexibility, such as the ability to change a business process on-the-fly. Handling diverse applications can further add to the complexities involved in workflow creation and management.

Many applications for workflow tools are internal to a business or organization. With the advent of networked computers having modems or other type communications links, computer systems at remote locations can now communicate easily with one another. Such enhanced communication allows computer system workflow applications to be used between remote facilities within a company. An example would include forwarding a customer order from a corporate headquarters to a remote field sales office for verification by the appropriate sales person, and returning a verification to the headquarters. Workflow applications also can be of particular utility in processing business transactions between different companies. In a typical application, two companies having a buyer-seller relationship may desire to automate the generation and processing of purchase orders, product shipments, billing, and collections.

For example, an application targeting a specific problem, such as customer relationship management (CRM), or a specific vertical market, such as financial services, can be built around a workflow. Such kind of application commonly implements a number of different business processes. Building the logic that drives those processes on a common workflow foundation such as Windows Workflow Foundation can make the application faster to build, quicker to change, and easier to customize. Moreover automating such processes can result in significant efficiency improvements, which are not otherwise possible. However, such inter-company application of workflow technology requires co-operation of the companies and proper interfacing and proper persistence service implementation of the individual company's existing computer systems and applications.

Thus far, workflow application tools have been developed which provide some capability for automating business workflow by defining workflow schedules. Nonetheless, the ability to further establish a higher degree of isomorphism between objects found in the problem space (the enterprise/process domain) and those employed in the solution (the actual workflow model/definition) is burdensome, and nonetheless is considered an important requirement to a high quality software.

Therefore, there is a need to overcome the aforementioned exemplary deficiencies associated with conventional systems and devices.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

The subject innovation provides for systems and methods that objectify view of workflows and management behavior via an access component (e.g., GetWorkflow<workflow> method) that provides a host access to the workflow instance, wherein custom features can be defined for interaction during run time. Such custom features (e.g., strongly typed workflow) can include, a property(ies), a method(s), an event(s), an interface and the like. Moreover, the subject innovation provides for a workflow instance that is being created from a workflow definition, and is typically not a proxy, facade, or wrapper around the actual workflow instance object. Thus, the actual workflow instance can be accessed directly. Accordingly, the workflow can be exposed as an object type or class, wherein new members can be added and the workflow extended. Such provides flexibility and enables a user to interact with custom properties.

In a related aspect, custom methods and properties can be called during data exchange between a host and the workflow instance. The host can interact with the workflow instance to associate a custom behavior with the workflow class. For example, the host can subscribe to custom events for accessing such workflow instance, and manipulate the workflow as an object. Enriched types for the workflow can be defined programmatically and/or through a visual tool.

According to a methodology of the subject innovation, a new workflow definition that has custom properties, custom methods, custom events, and the like can be defined from a base workflow definition. Moreover, the host application can request a workflow instance from a workflow provider thru an identification associated with the workflow instance. Such identification uniquely identifies the instance of the workflow and can be generated programmatically or assigned/accessed by the host application. The workflow provider can generate/return an instance of the workflow, and the user can interact with such instance by calling class members such as properties, methods, events and the like. Subsequently, and upon completion of such interaction the workflow instance can be saved.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 illustrates an exemplary system diagram of a host application that interacts with workflow via an access component, to define custom features for a workflow.

FIG. 2 illustrates custom features built upon a base workflow definition.

FIG. 3 illustrates a block diagram of a host application interaction with a workflow instance, wherein custom features can be built upon a base class.

FIG. 4 illustrates an exemplary methodology of employing a workflow type with custom properties.

FIG. 5 illustrates an exemplary sequence diagram for flow of information between processes according to one particular aspect of the subject innovation.

FIG. 6 illustrates an exemplary methodology of saving instances of the workflow.

FIG. 7 illustrates an exemplary methodology for loading instances of the workflow.

FIG. 8 illustrates a further methodology for data exchange between a host and workflow instance according to an exemplary aspect of the subject innovation.

FIG. 9 illustrates an exemplary environment for implementing various aspects of the subject innovation.

FIG. 10 is a schematic block diagram of an additional-computing environment that can be employed to enrich a workflow according to an aspect of the subject innovation.

### DETAILED DESCRIPTION

The various aspects of the subject invention are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

As used herein, the terms “component,” “system”, “service” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The term “exemplary” is used herein to mean serving as an example, instance, or illustration. Any aspect or design described herein as “exemplary” is not necessarily to be construed as preferred or advantageous over other aspects or designs.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term computer program as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

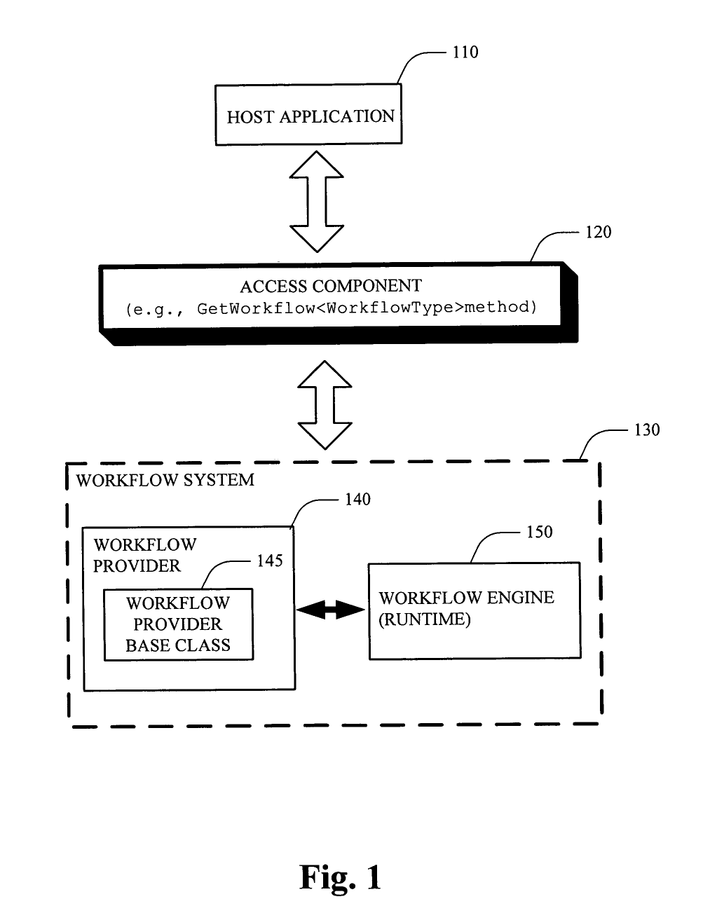

Turning initially to FIG. 1, a block diagram for a workflow system 130 is illustrated that provides a host 110 access to the workflow instance, wherein custom features can be defined for interaction during run time. Such custom features (e.g., strongly typed workflow) can include, a method(s), an event(s), an interface and the like. The workflow can model a human or system process that is defined as a map of activities. An activity is an act in a workflow, and is the unit of execution, re-use, and composition for a workflow. The map of activities expresses rules, actions, states, and their relation. Typically, the workflow runs via the workflow engine/runtime 150, and the workflow runtime requires an external application to host it, according to a few rules, as depicted by the host 110.

The host 110 interacts with the workflow system 130, via an access component 120 that provides access to the workflow instance, wherein custom features can be defined for interaction during run time. Such custom features (e.g., strongly typed workflow) can include, a method(s), an event(s), a property (ies), an interface and the like. Accordingly, the workflow can be exposed as an object type or class, wherein new members can be added and the workflow extended. Such provides flexibility and enables a user to interact with custom properties.

Moreover, thru such access component 120, the host 110 can exchange data with a workflow instance of the workflow system 130, as described in detail infra. The host 110 can be responsible for a number of additional and critical aspects, such as the creation of one or more workflows, marshaling of calls between various components as needed for proper execution of the workflow; and setup of isolation mechanisms. In addition, the host 110 can create multiple processes to take advantage of multiple CPUs in a machine for scalability reasons, or to run a large number of workflow instances on a farm of machines. The host 110 can further control the policies to apply when a workflow is subject to a long wait, listen for specific events and communicate them to a user or administrator, set timeouts and retries for each workflow, expose performance counters, and write log information for debugging and diagnostic purposes.

A workflow associated with the workflow system 130 can communicate with the outside world through a service established specifically for that purpose, wherein such service can raise events that event-driven activities inside the workflow will hook up. Likewise, the service exposes public methods for the workflow to call and send data to the host 110. The Workflow can be defined in the form of a schedule for execution in a computer system. A schedule can include a set of actions having a specified concurrency, dependency, and transaction attributes associated therewith. Each schedule has an associated schedule state, which includes a definition of the schedule, the current location within the schedule, as well as active or live data and objects associated with the schedule. Within a schedule, transaction boundaries may exist based on groupings of actions. In this regard, a transaction may encompass individual actions, or transactions, or groups thereof. As discussed further hereinafter, actions may be grouped into sequences, which are executed in serial fashion, as well as tasks in which the actions are executed concurrently. Based on the groupings, therefore, concurrency attributes may be resolved for the actions and transactions within a schedule.

As illustrated in FIG. 1, the access component 120 can create/retrieve a workflow instance and provide it to the host application for further interaction. The access component 120 can supply a handle to the workflow instance for the host 110 to access properties, methods and events. As such, access component 120 can provide an instance of a workflow, wherein the workflow instance is of a workflow type.

The following provides an exemplary definition for the access component 120, wherein the method GetWorkflow<WorkflowType> supplies an access to the running workflow definition and its custom properties, methods and events (e.g., when the workflow is idled). Such usage of a generics based mechanism for the (<WorkflowType>) can typically facilitate obtaining a strongly typed workflow definition in a type-safe manner.

public class InteractiveWorkflow

{

public event EventHandler<SuspensionEventArgs>

Suspended;

public event EventHandler<EventArgs>

Completed;

public InteractiveWorkflow( ) { }
public InteractiveWorkflow(Guid

workflowInstanceId) { }

public InteractiveWorkflow(WorkflowInstance

workflowInstance) { }

public IRootActivity Workflow {get;}
public WorkflowSuspendType SuspendType { get; }
public string Interactionidentifier { get; }
public string UserName { get; }
public WorkflowType GetWorkflow<WorkflowType>( )

where WorkflowType : Activity

public void StartWorkflow( ) { }
public void ResumeWorkflow (string action) { }
public void Save( ) { }

...
}

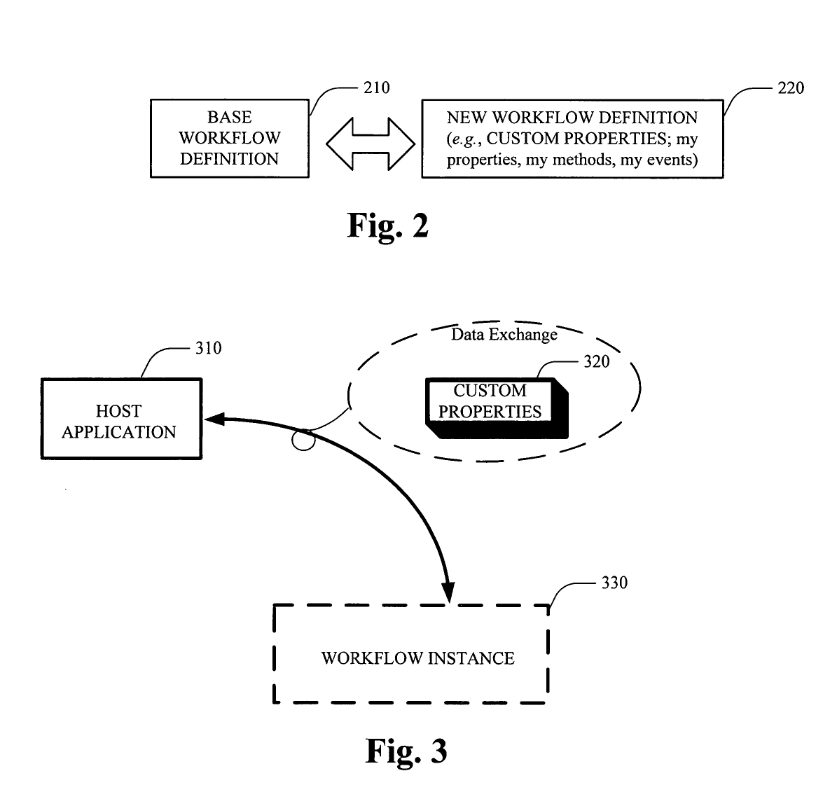

Referring now to FIG. 2 there is illustrated a block diagram of a new workflow type 220 and custom properties that are created from a base workflow definition 210 in accordance with an aspect of the subject innovation. The type can be extended by adding class members. Typically, key building block in such framework are Activities, which represent a task(s) or single logical unit of work that are performed when an associated Execute method is invoked by the framework. Each activity can provide an object model consisting of properties, methods and events that the developer can program against in application code, (e.g., similar to programming against UI controls and components). There exist different kinds of activities, and the subject innovation enables independent parties to build custom activities, similar to UI controls and the like.

For example, the framework can define a core set of activity base classes, as well as few specific activities. Such can include: StartActivity, and StopActivity (representing starting and stopping points in a workflow); CodeActivity (allowing the workflow developer to implement the functionality associated with the activity in an event handler within the workflow type); ControlFlowActivity (allowing workflow developers to introduce branching logic into the workflow based on conditions and rules); SuspendableActivity (allowing workflow developers to model a suspension in the execution of the workflow, either in terms of time, or by switching the current user, e.g., DelayActivity and SwitchUserActivity); InteractiveActivity (allowing workflow developers to model a user interaction point, where an action from the end-user determines when and how the execution within a workflow proceeds) such InteractiveActivity can be treated as a type of SuspendableActivity that suspends the execution until a valid action is performed); CompositeActivity (allowing the workflow developer to group activities together); LoopActivity (being an example of a CompositeActivity that repeats the execution of its contained activities); IMultiActionActivity: (an interface being implemented by activities that support multiple actions, and require one of those actions to be selected before execution can proceed and the InteractiveActivity can implements such interface); IMultiResultActivity (an interface being implemented by activities that generate one of a set of possible results during their execution) and ControlFlowActivity implements this interface; ISuspendableActivity (an interface being implemented by activities that can suspend execution of the workflow for a set of specific wait conditions.)

The workflow can start execution by executing the contained StartActivity, and end when the StopActivity is executed. During the course of executing, each activity can be checked to verify if it can be executed. If the activity cannot continue to execute because it is waiting for some information from the host (e.g., messages, timers, and the like) the workflow is suspended, for example. If an activity can be executed, an associated Execute method is invoked, and if the method returns a success result, the appropriate activity transition is used to determine the next activity. Moreover, workflows can be suspended for a number of reasons during their lifetime, such as: canceling of an activity execution, inability for an activity to continue execution because it is waiting for some information such as messages, timers, and the like from the host, a specific delay introduced to postpone subsequent execution, and switching of user context requiring subsequent execution to be carried out by a different user. Once suspended, the workflow instance can be serialized into a database or equivalent storage, from which it can be subsequently retrieved, deserialized, and resumed. A workflow can also enter an error state, if an activity execution results in an error, which is not handled.

FIG. 3 illustrates a block diagram of a host application 310 interaction with a workflow instance 330, wherein custom properties 320 can be built upon a base class, wherein data is being passed in and out of the workflow, to form an interactive workflow. During the course of executing, each activity can be checked to verify if it can be executed. If the activity cannot execute the workflow can be suspended, for example. If an activity can be executed, an associated Execute method can be invoked, and if the method returns a success result, the appropriate activity transition is used to determine the next activity. As illustrated the host application 310 can exchange data with the workflow instance 330 (e.g., obtain data). Such enables a controlled/synchronous data exchange between the workflow instance and a host application, wherein custom methods and properties can be called. Thus, the host application 310 can interact with the workflow instance to associate a custom behavior with the workflow class. For example, the host can subscribe to custom events for accessing such workflow instance, to manipulate the workflow as an object. Moreover, enriched types for the workflow can be defined programmatically and/or through a visual tool.

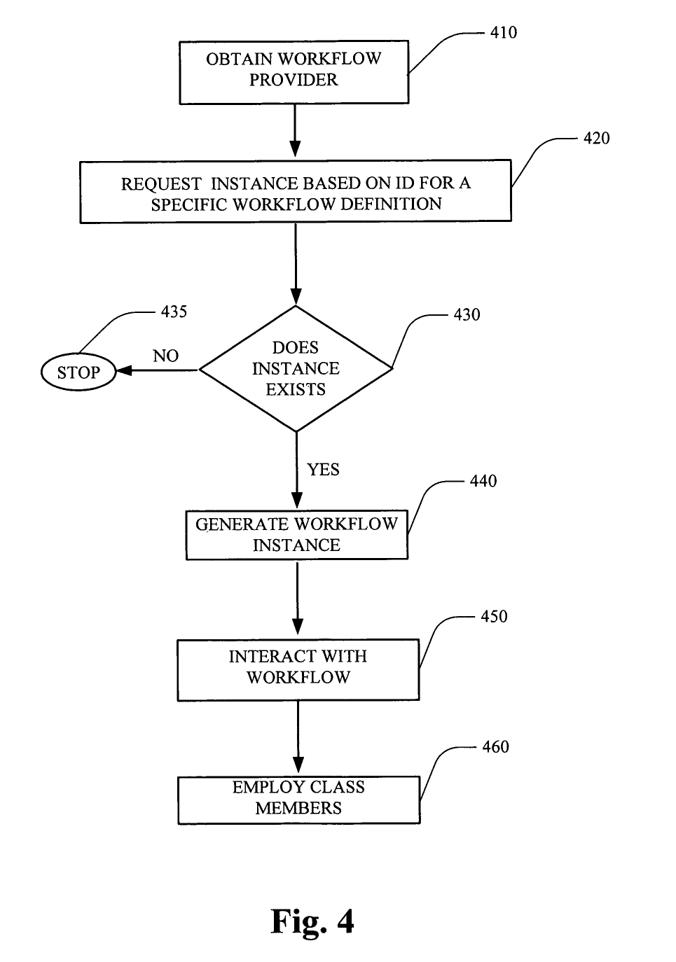

FIG. 4 illustrates a related methodology of employing custom features and/or defining a new workflow definition, in accordance with an exemplary aspect of the subject innovation. Such new workflow definition can have custom properties, custom methods, custom events, and the like, which are defined from a base workflow definition. While the exemplary method is illustrated and described herein as a series of blocks representative of various events and/or acts, the subject innovation is not limited by the illustrated ordering of such blocks. For instance, some acts or events may occur in different orders and/or concurrently with other acts or events, apart from the ordering illustrated herein, in accordance with the innovation. In addition, not all illustrated blocks, events or acts, may be required to implement a methodology in accordance with the subject innovation. Moreover, it will be appreciated that the exemplary method and other methods according to the innovation may be implemented in association with the method illustrated and described herein, as well as in association with other systems and apparatus not illustrated or described. Initially, and 410 a workflow provider is obtained, and the host application can then request a workflow instance from such workflow provider thru an identification associated with the workflow instance at 420. Such identification uniquely identifies the instance of the workflow and can be generated programmatically or assigned by the host application. At 430, a verification is performed to check whether such workflow instance exists. If not, the methodology stops at 435.

Otherwise, the methodology proceeds to act 440 wherein the workflow provider can generate an instance of the workflow. The host application can then interact with such instance at 450, by calling class members such as properties, methods, events and the like at 460. Upon completion of such interaction, the workflow process can be saved, as described in detail infra.

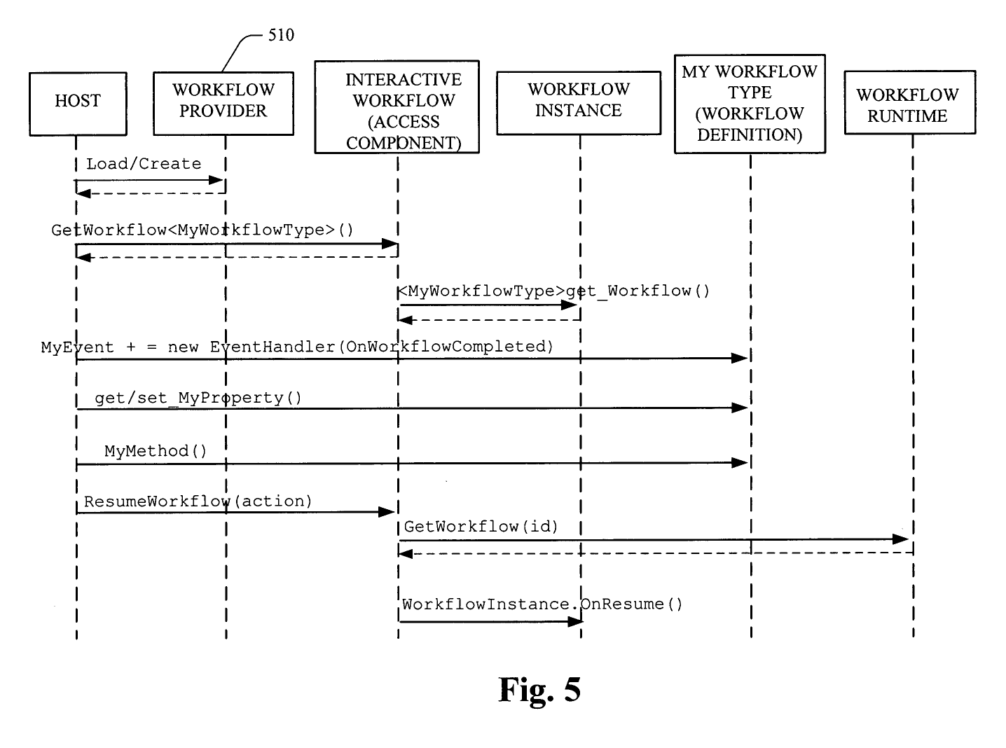

FIG. 5 illustrates an exemplary sequence diagram for flow of information between processes according to one particular aspect of the subject innovation. Initially, the host application can employ the access component (e.g., GetWorkflow <WorkflowType>) to obtain workflow definition and its custom properties, methods and events (e.g., when the workflow is idled). Such usage of a generics based mechanism for the <WorkflowType> can typically facilitate obtaining a strongly typed workflow definition in a type-safe manner. The custom features (e.g., strongly typed workflow) can include, a method(s), an event(s), a property(ies) an interface and the like. Accordingly, the workflow can be exposed as an object type or class, wherein new members can be added and the workflow extended. Such provides flexibility and enables a user to interact with custom properties.

The workflow provider 510 can create/retrieve an instance of the workflow, and the host application can interact with such instance by calling class members such as properties, methods, events and the like. As such, Based on the workflow instance identification (e.g., ID number), the workflow instance can then be accessed (e.g., via the host application). The host can interact with the workflow instance through its custom behavior associated with the workflow type/class. For example, the host can subscribe to custom events for accessing such workflow instance, to manipulate the workflow as an object. Enriched types for the workflow definition can be defined programmatically and/or through a visual tool.

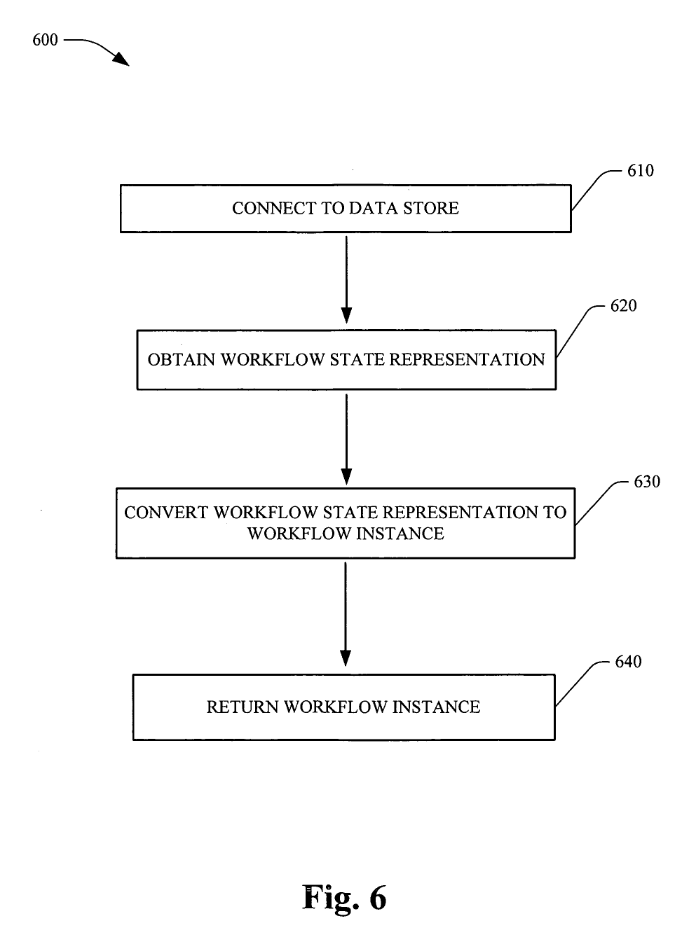

FIG. 6 illustrates a related methodology 600 for loading an instance of the workflow during a data exchange with the host application. As illustrated in FIG. 6, access to a persistence store is provided at 610, which stores a workflow instance representation. Subsequently, and at 620 the workflow instance state representation is obtained from the corresponding persistence store. Such representation can then be converted to workflow instances at 630. Next, and at 640 the workflow instance is provided to the host application, wherein the host can interact with the workflow instance through its custom behavior associated with the workflow type/class. For example, the host can subscribe to custom events for accessing such workflow instance, to manipulate the workflow as an object. Enriched types for the workflow can be defined programmatically and/or through a visual tool.

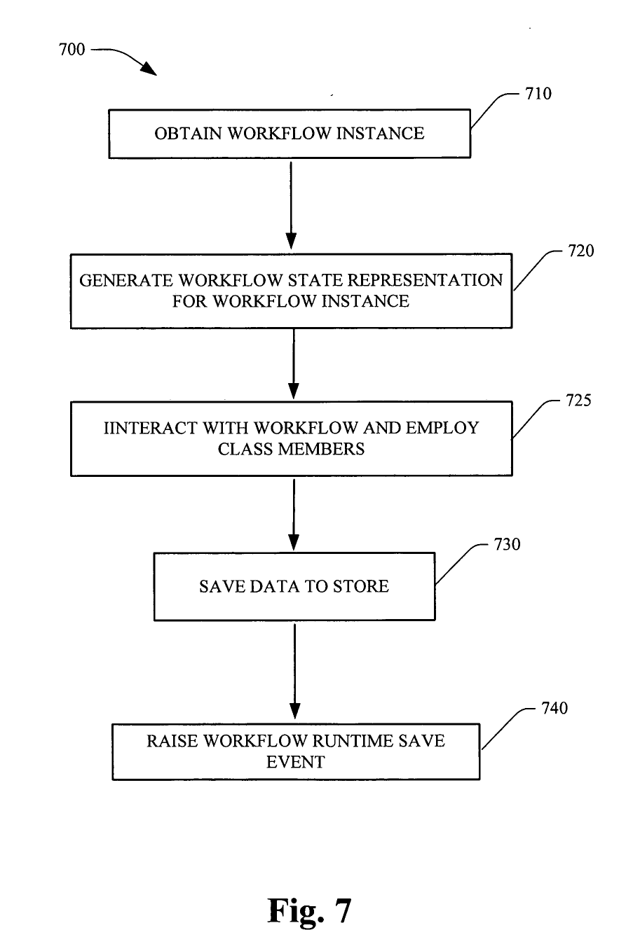

Similarly, and as illustrated in FIG. 7, for saving an instance of the workflow, the workflow instance is obtained at 710. Subsequently and at 720, a workflow state is generated that is a representation of such workflow instance. The host application can then interact with such instance at 725, by calling class members such as properties, methods, events and the like. Data related to such interaction/representation can then be saved to the data store and/or persistence service implementation at 730. As such and at 740, a workflow runtime save event can be raised, wherein the workflow instance is saved and/or accessed. Thus, the subject innovation enables a new workflow definition that has custom properties, custom methods, and custom events, to be defined from a base workflow definition.

The workflow provider can create/retrieve an instance of the workflow, and the developer can interact with such instance by calling class members such as properties, methods, events and the like.

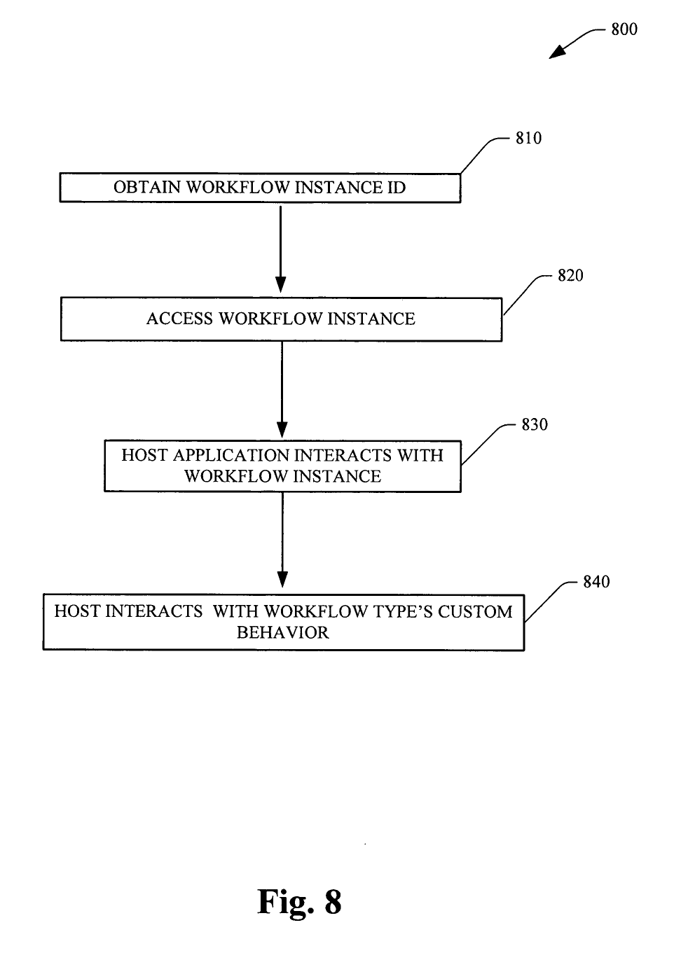

FIG. 8 illustrates a particular methodology 800 of accessing a running workflow according to an aspect of the subject innovation. Initially and at 810, the host application can access a running workflow, by obtaining a workflow instance identification. Subsequently, and at 820 the workflow instance can be accessed via a call load method, wherein a tabular arrangement corresponds workflow instances with associate identifications (IDs). Next, and at 830 the host application can interact with the workflow. During such interaction and at 840, the host can interact with the custom behavior of the workflow's type. For example, the host can subscribe to custom events for accessing such workflow instance, to manipulate the workflow as an object. Enriched types for the workflow can be defined programmatically and/or through a visual tool.

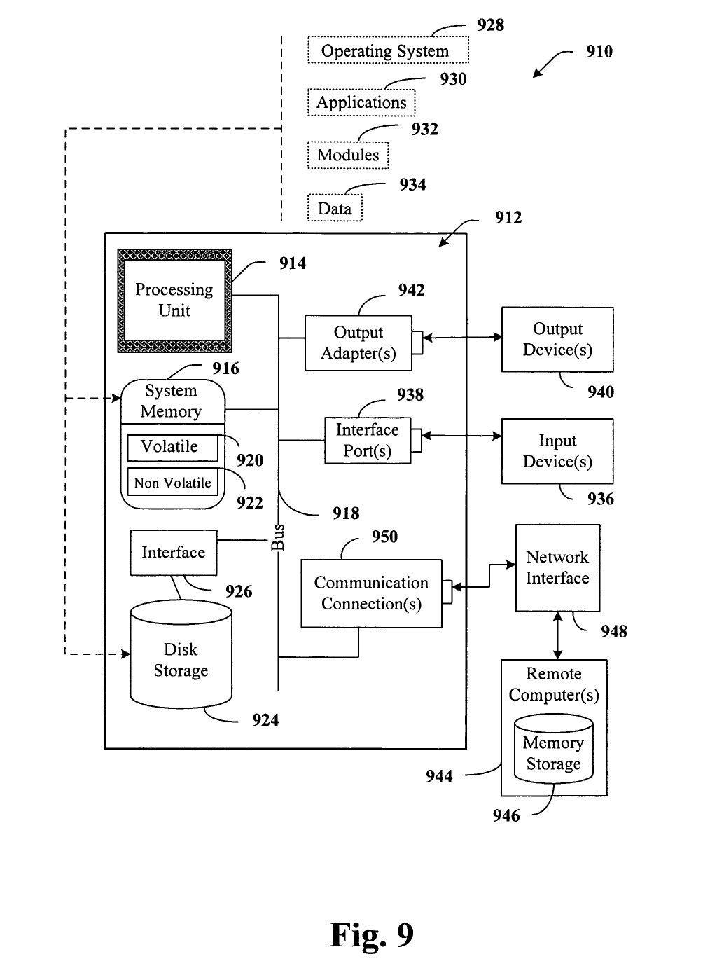

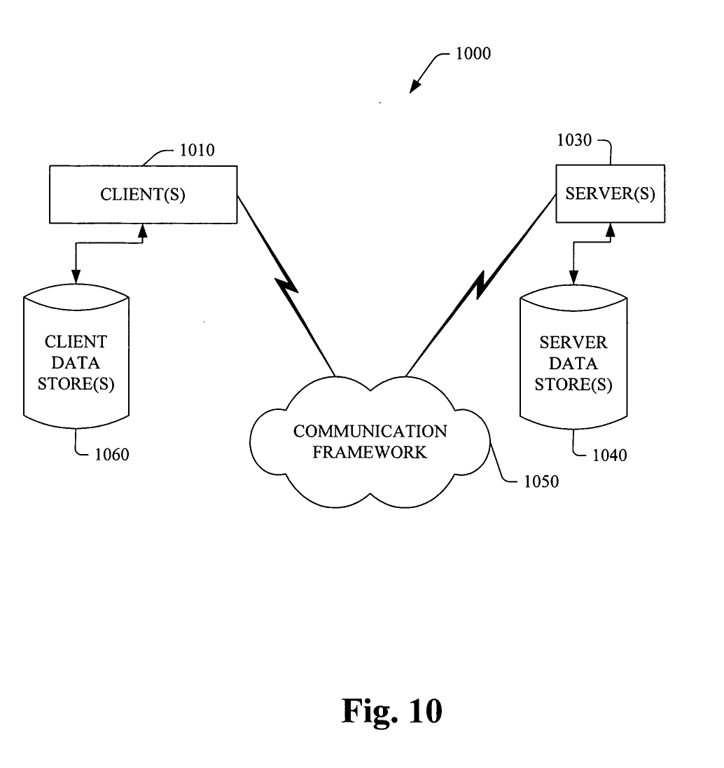

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the innovation also may be implemented in combination with other program modules. Generally, program modules include routines, programs, components, data structures, etc. that perform particular tasks and/or implement particular abstract data types. Moreover, those skilled in the art will appreciate that the innovative methods can be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the invention can be practiced on stand-alone computers. In a distributed computing environment, program modules may be located in both local and remote memory storage devices.

With reference to FIG. 9, an exemplary environment 910 for implementing various aspects of the subject innovation is described that includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/non-removable, volatile/non-volatile computer storage media. FIG. 9 illustrates, for example a disk storage 924. Disk storage 924 includes, but is not limited to, devices like a magnetic disk drive, floppy disk drive, tape drive, Jaz drive, Zip drive, LS-100 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that various components described herein can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940 that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

FIG. 10 is a schematic block diagram of a sample-computing environment 1000 that can be employed to implement a workflow implementation of the subject innovation. The system 1000 includes one or more client(s) 1010. The client(s) 1010 can be hardware and/or software (e.g., threads, processes, computing devices). The system 1000 also includes one or more server(s) 1030. The server(s) 1030 can also be hardware and/or software (e.g., threads, processes, computing devices). The servers 1030 can house threads to perform transformations by employing the components described herein, for example. One possible communication between a client 1010 and a server 1030 may be in the form of a data packet adapted to be transmitted between two or more computer processes. The system 1000 includes a communication framework 1050 that can be employed to facilitate communications between the client(s) 1010 and the server(s) 1030. The client(s) 1010 are operably connected to one or more client data store(s) 1060 that can be employed to store information local to the client(s) 1010. Similarly, the server(s) 1030 are operably connected to one or more server data store(s) 1040 that can be employed to store information local to the servers 1030.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer implemented system comprising the following computer executable components:
an access component that provides a host with access to a workflow instance; and
the host that calls custom features during a data exchange with the workflow instance.

2. The computer implemented system of claim 1, the custom features are at least one of methods, properties and events for strongly typed workflows.

3. The computer implemented system of claim 1, a workflow associated with the workflow instance exposable as an object type or class.

4. The computer implemented system of claim 3, a definition of the workflow extendable via new member additions.

5. The computer implemented system of claim 1, a custom workflow definition associated with the workflow instance suspendable during data exchange with the host.

6. The computer implemented system of claim 5 further comprising a workflow provider that retrieves the workflow instance.

7. The computer implemented system of claim 5, the workflow instance resumable by an action of the host.

8. The computer implemented system of claim 5, a workflow definition with a base class to derive a new workflow definition therefrom.

9. A computer implemented method comprising the following computer executable acts:
accessing a workflow instance via an access component of the workflow system; and
calling custom features during a data exchange between a host and the workflow instance.

10. The computer implemented method of claim 9 further comprising requesting the workflow instance based on an identification associated therewith.

11. The computer implemented method of claim 10 further comprising verifying existence of the workflow instance.

12. The computer implemented method of claim 9 further comprising employing class members during data exchange between the host and the workflow instance.

13. The computer implemented method of claim 9 further comprising generating a workflow state representation for the workflow instance.

14. The computer implemented method of claim 13 further comprising defining custom features during data exchange between the host and workflow instance.

15. The computer implemented method of claim 14 further comprising associating custom behaviors with a workflow definition or type associated with the workflow instance.

16. The computer implemented method of claim 15 further comprising subscribing to custom events by the host.

17. The computer implemented method of claim 16 further comprising programmatically defining enriched types for the workflow instance.

18. The computer implemented method of claim 17 further comprising extending the workflow definition or type by adding new members.

19. The computer implemented method of claim 18 further comprising calling a save method to store the workflow instance.

20. A computer implemented system comprising the following computer executable components:
means for accessing a workflow instance based on custom workflow definition associated therewith; and
means for creating new workflow from a base workflow definition.
